(19) United States
(12) Patent Application Publication
(10) Pub. No.: US 2024/0032156 A1
(43) Pub. Date: Jan. 25, 2024

(54) SHEATHED HEATER AND SUBSTRATE SUPPORT DEVICE INCLUDING THE SAME

(71) Applicant: NHK SPRING CO., LTD., Yokohama-shi (JP)

(72) Inventors: Naoya KIDA, Yokohama-shi (JP); Jun FUTAKUCHIYA, Yokohama-shi (JP); Daisuke FUJINO, Yokohama-shi (JP); Yuki TANI, Yokohama-shi (JP)

(21) Appl. No.: 18/374,271

(22) Filed: Sep. 28, 2023

Related U.S. Application Data
(63) Continuation of application No. PCT/JP2022/005143, filed on Feb. 9, 2022.

(30) Foreign Application Priority Data
Mar. 31, 2021 (JP) 2021-060610

(51) Int. Cl. H05B 3/56; H05B 3/18

(52) U.S. Cl. CPC H05B 3/56; H05B 3/18; H05B 2203/016

(57) ABSTRACT

A sheathed heater with improved reliability is provided. Alternatively, a substrate support device including the sheathed heater with improved reliability is provided. The sheathed heater of the present invention includes a first metal wire, a first terminal connected to a first end of the first metal wire, a first conductive flexible member connected to the first terminal and connected to a second metal wire, a second terminal connected to a second end of the first metal wire, and a second conductive flexible member connected to the second terminal and connected to a third metal wire, wherein the first conductive flexible member and the second conductive flexible member are arranged adjacent to each other.

### CROSS-REFERENCE TO RELATED APPLICATIONS

This application is a Continuation of International Patent Application No. PCT/JP2022/005143, filed on Feb. 9, 2022, which claims the benefit of priority to Japanese Patent Application No. 2021-060610, filed on Mar. 31, 2021, the entire contents of which are incorporated herein by reference.

### FIELD

The present invention relates to a sheathed heater. Alternatively, the present invention relates to a substrate support device including the sheathed heater.

### BACKGROUND

A sheathed heater is a heater in which a heating wire is held in a metal tubular sheath, and an insulating material having high thermal conductivity is filled in a gap between the metal sheath and the heating wire. Since a surface of a heating element is electrically insulated, the sheathed heater can directly heat gas, liquid, metal, or the like. Further, the sheathed heater can be laid out in an arbitrary shape, and is used for various applications because of its convenience. Therefore, there is an increasing demand for a sheathed heater having a smaller diameter so as to be able to be laid out in a more complicated shape corresponding to various needs. On the other hand, since the sheathed heater heats the heating wire by supplying electricity to the heating wire, a contrivance for preventing a short circuit or breakage of the heating wire is also required.

For example, for a purpose of suppressing disconnection of a heating wire, Japanese Laid-Open Patent Publication No. 2018-181586 discloses a sheathed heater including a metal sheath, a heating wire having a band shape, the heating wire arranged with a space within the metal sheath so as to rotate with respect to an axis direction of the metal sheath, an insulating material arranged in the space, and connection terminals arranged at one end of the metal sheath, the connection terminals electrically connected with both ends of the heating wire respectively.

Further, for a purpose of relaxing thermal strain caused by thermal stress generated in a connection portion between the sheath and the lead wire, Japanese Laid-Open Patent Publication No. 2011-253691 describes a lead wire connection terminal of a sheathed heater that connects an end portion of a heating wire of the sheathed heater and an end portion of the lead wire via a connection conductor having springiness.

### SUMMARY

An object of an embodiment of the present invention is to provide a sheathed heater with improved reliability. Another object of an embodiment of the present invention is to provide a substrate support device including the sheathed heater with improved reliability.

According to an embodiment of the present invention, there is provided a sheathed heater including a first metal line, a first terminal connected to a first end of the first metal line, a first conductive flexible member connected to the first terminal and connected to a second metal line, a second terminal connected to a second end of the first metal line, and a second conductive flexible member connected to the second terminal and connected to a third metal line, wherein the first conductive flexible member and the second conductive flexible member are arranged adjacent to each other.

The first conductive flexible member and the second conductive flexible member may be selected from a metal coil, a twisted wire, and a flat knitted wire.

The sheathed heater has a structure including a bend, and the first conductive flexible member and the second conductive flexible member are arranged at the bend.

The conductive flexible members are metal coils, and a pitch of a second metal coil may be larger than a pitch of a first metal coil at the bend.

The sheathed heater may include two or more bends.

The sheathed heater may further include a metal sheath covering the first metal wire, the first terminal, the second metal wire, the first conductive flexible member, the second terminal, the third metal wire, and the second conductive flexible member, and a curvature radius of the bend may be more than double the diameter of the metal sheath.

The sheathed heater may further include insulating material particles filled in the metal sheath, the insulating material particles may be arranged between the first conductive flexible member and the second conductive flexible member, and a distance between the first conductive flexible member and the second conductive flexible member may be 0.14 mm or more.

Further, according to an embodiment of the present invention, there is provided a substrate support device including any one of the sheathed heaters described above.

### BRIEF DESCRIPTION OF DRAWINGS

FIG. 1 is a schematic view of a sheathed heater 100 according to an embodiment of the present invention.

FIG. 2 is a schematic view showing a cross-sectional structure of the sheathed heater 100 according to an embodiment of the present invention.

FIG. 3 shows a cross-sectional end view of a bend 191 according to an embodiment of the present invention.

FIG. 4 is a perspective view of a substrate support device 1000 according to an embodiment of the present invention.

### DESCRIPTION OF EMBODIMENTS

Hereinafter, a sheathed heater and a substrate support device according to an embodiment of the present invention will be described with reference to the drawings. In addition, the following embodiments are examples of the sheathed heater and the substrate support device of the present invention, and the sheathed heater and the substrate support device of the present invention are not limited to the following embodiments.

In addition, although the drawings may be schematically represented with respect to the width, thickness, shape, and the like of each part as compared with an actual embodiment for clarity of the description, the drawings are merely examples, and do not limit the interpretation of the present invention. In addition, in the present specification and the drawings, elements having the same functions as those described with respect to the drawings already shown are denoted by the same reference symbols, and redundant description thereof may be omitted.

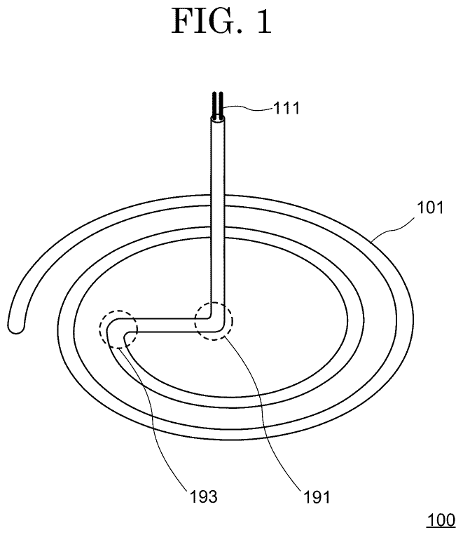

FIG. 1 is a schematic diagram of a sheathed heater 100 according to an embodiment of the present invention. Two non-heating wires 111 are drawn out from one end of a metal sheath 101. As an example, although the sheathed heater 100 has a spiral arrangement in a plan view viewed from a side of the non-heating wire 111, the arrangement of the sheathed heater 100 is not limited thereto. Further, the sheathed heater 100 has at least one bend. Alternatively, the sheathed heater 100 may have two or more bends. In FIG. 1, although an example in which the sheathed heater 100 includes a bend 191 and a bend 193 is shown, the present invention is not limited thereto, and three or more bends may be provided.

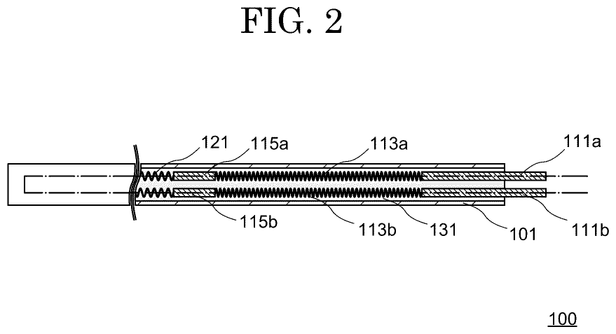

FIG. 2 is a schematic diagram showing a cross-sectional structure of the sheathed heater 100 according to an embodiment of the present invention. In addition, FIG. 2 shows a structure in which the sheathed heater 100 is arranged linearly. The sheathed heater 100 includes a heating wire (also referred to as a first metal wire) 121, a first terminal 115a connected to one end of the heating wire 121, and a first conductive flexible member 113a connected to the first terminal 115a and connected to a first non-heating wire (also referred to as a second metal wire) 111a. Further, the sheathed heater 100 includes a second terminal 115b connected to the other end of the heating wire 121, and a second conductive flexible member 113b connected to the second terminal 115b and connected to a second non-heating wire (also referred to as a third metal wire) 111b. In the sheathed heater 100, the first conductive flexible member 113a and the second conductive flexible member 113b are arranged adjacent to each other. Further, the first terminal 115a and the second terminal 115b are arranged adjacent to each other. The first non-heating wire 111a and the second non-heating wire 111b are arranged adjacent to each other.

In FIG. 2, the alternate long and short dash line indicate a line passing through center of the heating wire 121, the first terminal 115a, the first conductive flexible member 113a, and the first non-heating wire 111a, and a line passing through center of the heating wire 121, the second terminal 115b, the second conductive flexible member 113b, and the second non-heating wire 111b. The heating wire 121 has an arrangement folded back at a tip of the sheathed heater 100. Although the first terminal 115a is a terminal for connecting the heating wire 121 and the first non-heating wire 111a, in the present embodiment, the first terminal 115a and the first non-heating wire 111a are connected via the first conductive flexible member 113a. In addition, although the second terminal 115b is a terminal for connecting the heating wire 121 and the second non-heating wire 111b, in the present embodiment, the second terminal 115b and the second non-heating wire 111b are connected via the second conductive flexible member 113b. The first non-heating wire 111a, the first conductive flexible member 113a, the first terminal 115a, the heating wire 121, the second terminal 115b, the second conductive flexible member 113b, and the second non-heating wire 111b are electrically connected to each other.

In the sheathed heater 100, a metal sheath 101 covers the heating wire 121, the first terminal 115a, the first conductive flexible member 113a, the first non-heating wire 111a, the second terminal 1151o, the second conductive flexible member 113b, and the second non-heating wire 111b. The metal sheath 101 is filled with insulating material particles 131. The insulating material particles 131 are arranged between the heating wire 121 folded back at the tip of the sheathed heater 100, between the first terminal 115a and the second terminal 115b, between the first conductive flexible member 113a and the second conductive flexible member 113b, and between the first non-heating wire 111a and the second non-heating wire 111b. Further, in the metal sheath 101, the insulating material particles 131 are also arranged between the heating wire 121, the first terminal 115a, the first conductive flexible member 113a, the first non-heating wire 111a, the second terminal 115b, the second conductive flexible member 113b, and the second non-heating wire 111b, and the metal sheath 101.

In an embodiment, one type of particles selected from magnesium oxide particles, aluminum oxide particles, boron nitride particles, silicon nitride particles, aluminum nitride particles and aluminum nitride based ceramic particles can be used as the insulating material particles 131. In an embodiment, the magnesium oxide particles are preferably used as the insulating material particles 131.

In an embodiment, the heating wire 121 may use a conductor that generates Joule heat by being energized. Specifically, it may comprise a metal selected from tungsten, tantalum, molybdenum, platinum, nickel, chromium, cobalt, and zirconium. The metal may be an alloy containing these metals, for example, an alloy of nickel and chromium, an alloy containing nickel, chromium, and cobalt, or a zirconium alloy. In FIG. 2, although an example of the heating wire 121 is shown in which a linear conductor has a coil-like structure, the present invention is not limited thereto, and a belt-like conductor may have a coil-like structure.

In an embodiment, the first terminal 115a, the first conductive flexible member 113a, the first non-heating wire 111a, the second terminal 115b, the second conductive flexible member 113b, and the second non-heating wire 111b constitute a non-heating region. For these members arranged in the non-heating region, a conductor that does not generate Joule heat or hardly generates Joule heat by energizing can be used. In an embodiment, the members arranged in the non-heating region may use a metal selected from pure iron, cast iron, iron alloys, pure nickel, nickel alloys, pure copper, and copper alloys. Although FIG. 2 shows an example of a metal coil which is formed in a coil-like configuration as the first conductive flexible member 113a and the second conductive flexible member 113b, the conductive flexible members are not limited thereto. An elastic conductive wire can be used for the first conductive flexible member 113a and the second conductive flexible member 113b. For example, a metal coil in which a belt-like conductor is formed into a coil-like configuration may be used as the first conductive flexible member 113a and the second conductive flexible member 113b, or a twisted wire or a flat knitted wire may be used.

The metal sheath 101 is a cover for protecting the heating wire 121 and is a member for efficiently transmitting heat energy generated by the heating wire 121 to the object to be heated. Thermal conductivity of the heating wire 121 is preferably 200 W/mK or more. In an embodiment, pure aluminum, aluminum alloy, stainless steel, pure nickel, nickel alloy, pure copper, copper alloy, pure titanium, titanium alloy, and ceramics can be used as the metal sheath 101.

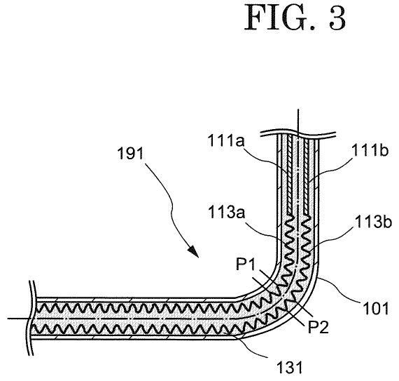

FIG. 3 shows a cross-sectional end view of the bend 191. The first conductive flexible member 113a and the second conductive flexible member 113b are arranged at the bend 191. Although not shown, the first conductive flexible member 113a and the second conductive flexible member 113b are also arranged in the bend 193. In FIG. 3, the alternate long and short dash line indicates a line passing through center of the sheathed heater 100. In the bend 191, the first conductive flexible member 113a and the second conductive flexible member 113b are arranged adjacent to each other, and a distance between the first conductive flexible member 113a and the second conductive flexible member 113b does not significantly change, preferably hardly changes, as compared to the bend 191 and the irrefrangible portion.

As in the present embodiment, in the conventional sheathed heater having a so-called duplex structure, in which the heating wire is bent in the metal sheath and two non-heating wires connected to the heating wire are drawn out, in the case where bending is applied to the sheathed heater, a nickel rod used for the non-heating wire is not expanded and contracted in an axial direction, the outer non-heating wire is pulled by path difference between an inside and an outside of the bend, and a force acts to move to the inside of the bend. As a result, the heating wires or the non-heating wires come close to each other, which causes a short circuit or damage.

In the sheathed heater 100 of the present embodiment, the first conductive flexible member 113a and the second conductive flexible member 113b arranged in the non-heating region expand and contract in a center line direction of the sheathed heater 100 or an axial direction in which the first conductive flexible member 113a and the second conductive flexible member 113b are arranged in the case where the first conductive flexible member 113a and the second conductive flexible member 113b are bent at the bend 191 and the bend 193. Therefore, in the case where the first conductive flexible member 113a and the second conductive flexible member 113b are metal coils, a pitch P2 of the second metal coil 113b is larger than a pitch P1 of the first metal coil 113a in the bend 191.

In the sheathed heater 100 of the present embodiment, even if the second conductive flexible member 113b located on an outer side of the bend 191 is pulled, the second conductive flexible member 113b is stretched to suppress the force to move to the inside of the bend, so that in the case the sheathed heater 100 is bent, an approach between the heating wires 121 which are folded back, an approach between the first terminal 115a and the second terminal 115b, an approach between the first conductive flexible member 113a and the second conductive flexible member 113b, and/or an approach between the first non-heating wire 111a and the second non-heating wire 111b can be suppressed. As a result, since the heating wires 121 which are folded back, and the first terminal 115a and the second terminal 115b, the first conductive flexible member 113a and the second conductive flexible member 113b, and/or the first non-heating wire 111a and the second non-heating wire 111b can ensure a stable insulating distance from each other, a short circuit in the sheathed heater 100 can be prevented.

Thus, in an embodiment, the sheathed heaters 100 may have a distance of 0.14 mm or more between the first conductive flexible member 113a and the second conductive flexible member 113b. In the sheathed heater 100 of the present embodiment using one type of particles selected from the magnesium oxide particles, the aluminum oxide particles, the boron nitride particles, the silicon nitride particles, the aluminum nitride particles and the aluminum nitride based ceramic particles as the insulating material particles 131 it is possible to prevent disconnection due to a short circuit in the AC rated voltage of 208 V by setting the distance between the first conductive flexible member 113a and the second conductive flexible member 113b to 0.14 mm or more, maintaining distances between the heating wires 121 which are folded back, between the first terminal 115a and the second terminal 115b, and between the first non-heating wire 111a and the second non-heating wire 111b to 0.14 mm or more.

In an embodiment, outer diameters of the first conductive flexible member 113a, the second conductive flexible member 113b, and the heating wire 121 are preferably 4.2 mm or less.

Further, in an embodiment, the shortest insulating distance between the heating wire 121, the first terminal 115a, the first conductive flexible member 113a, the first non-heating wire 111a, the second terminal 115b, the second conductive flexible member 113b, and the second non-heating wire 111b, and an inner diameter of the metal sheath 101 can be 0.33 mm to 0.99 mm in the case where the leakage current when 500 VAC to 1500 VAC is applied is 1 mA or less. Therefore, in the present embodiment, an outer diameter φ of the metal sheath 101 can be 3 mm to 10 mm.

In addition, in an embodiment, the sheathed heater 100 may have a curvature radius R of the bend 191 or the bend 193 being more than double the diameter of the metal sheath 101. That is, even if the bend 191 and the bend 193 are bent so as to have a radius of curvature R twice as large as the diameter of the metal sheath 101, the short circuit in the sheathed heater 100 can be prevented because a stable insulating distance can be secured due to a stretchability of the first conductive flexible member 113a and the second conductive flexible member 113b.

The first conductive flexible member 113a and the second conductive flexible member 113b may be applied to a region that is vertically raised from a heater plate surface of a substrate support device to be described later or rapidly folded back in a plane to obtain the effect of the present application. Further, in the case where the sheathed heater 100 is bent, it is possible to suppress displacement of the heating wires 121 which are folded back, the first terminal 115a and the second terminal 115b, the first conductive flexible member 113a and the second conductive flexible member 113b, and/or the first non-heating wire 111a and the second non-heating wire 111b, and thus it is possible to improve flexibility of layout the sheathed heater 100.

### [Substrate Support Device]

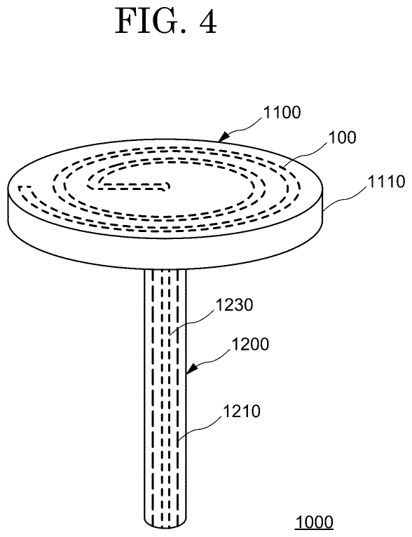

An example in which the sheathed heater 100 described above is applied to a substrate support device 1000 will be described. FIG. 4 is a perspective view of the substrate support device 1000 according to an embodiment of the present invention. The substrate support device 1000 includes a heater plate unit 1100 and a shaft 1200, and the sheathed heater 100 is arranged inside the heater plate unit 1100. The shaft 1200 is connected to a central portion of the heater plate unit 1100 opposite to an upper surface of the heater plate unit 1100. The shaft 1200 has a hollow structure 1210. A wire 1230 connected to the sheathed heater 100 and connected to an external control device (not shown) is arranged in the hollow structure 1210 of the shaft 1200. In the substrate support device 1000, an insulating film 1110 is formed on the heater plate unit 1100.

As described above, in the sheathed heater 100, the first conductive flexible member 113a and the second conductive flexible member 113b may be applied to a region that is vertically raised from the heater plate unit 1100 of the substrate support device 1000 or rapidly folded back in a plane of the heater plate unit 1100 to obtain the effect of the present application.

The substrate support device 1000 is arranged in a semiconductor manufacturing device used for processes such as chemical vapor deposition (CVD) and surface modification in manufacturing of a semiconductor device. Therefore, the substrate support device 1000 is used in a high-temperature environment of about 500° C. In the substrate support device 1000, the first conductive flexible member 113a and the second conductive flexible member 113b are arranged in the sheathed heater 100 to ensure a stable insulating distance, so that a short circuit from room temperature to a high temperature environment can be prevented.

According to an embodiment of the present invention, it is possible to provide a sheathed heater with improved reliability. Alternatively, according to an embodiment of the present invention, it is possible to provide a substrate support device including the sheathed heater with improved reliability.

What is claimed is:

1. A sheathed heater comprising:
a first metal wire;
a first terminal connected to a first end of the first metal wire, and a first conductive flexible member connected to the first terminal and a second metal wire; and
a second terminal connected to a second end of the first metal wire, and a second conductive flexible member connected to the second terminal and a third metal wire,
wherein the first conductive flexible member and the second conductive flexible member are arranged adjacent to each other.

2. The sheathed heater according to claim 1, wherein the first conductive flexible member and the second conductive flexible member are selected from a metal coil, a twisted wire, and a flat knitted wire.

3. The sheathed heater according to claim 1, wherein the sheathed heater has a structure including a bend, and
the first conductive flexible member and the second conductive flexible member are arranged at the bend.

4. The sheathed heater according to claim 3, wherein the conductive flexible members are metal coils, and
a pitch of a second metal coil is larger than a pitch of a first metal coil at the bend.

5. The sheathed heater according to claim 3, wherein the sheathed heater includes two or more bends.

6. The sheathed heater according to claim 3, further comprising: a metal sheath covering the first metal wire, the first terminal, the second metal wire, the first conductive flexible member, the second terminal, the third metal wire and the second conductive flexible member,
wherein a curvature radius of the bend is more than double the diameter of the metal sheath.

7. The sheathed heater according to claim 6, further comprising: insulating material particles filled in the metal sheath,
wherein the insulating material particles are arranged between the first conductive flexible member and the second conductive flexible member, and
a distance between the first conductive flexible member and the second conductive flexible member is 0.14 mm or more.

8. A substrate support device comprising: the sheathed heater according to claim 1.
